(19) United States
(12) Patent Application Publication
(10) Pub. No.: US 2009/0197224 A1
(43) Pub. Date: Aug. 6, 2009

(54) Language Learning Apparatus, Language Learning Aiding Method, Program, and Recording Medium

(75) Inventors: Ryuichi Nariyama, Shizuoka (JP); Naohiro Emoto, Irvine, CA (US)

Correspondence Address: PILLSBURY WINTHROP SHAW PITTMAN LLP, P.O BOX 10500, McLean, VA, 22102, US

(73) Assignee: Yamaha Corporation, Shizuoka-ken (JP)

(21) Appl. No.: 12/085,111

(22) PCT Filed: Nov. 16, 2006
(86) PCT No.: PCT/JP2006/322873

§ 371 Date: May 16, 2008

(30) Foreign Application Priority Data
Nov. 18, 2005 (JP) 2005-334614

(51) Int. Cl. G09B 19/00; G09B 5/00; G09B 5/04

(52) U.S. Cl. 434/156; 434/307 R; 434/319

(57) ABSTRACT

There is provided a language learning apparatus, which includes an inputting portion to which a voice signal is input, a time stretching portion which compresses or expands the voice signal in a time axis direction such that a phonation period of a voice indicated by the voice signal input into the inputting portion is matched with a phonation period of a model voice, a specifying portion which compares the voice signal which is compressed or expanded by the time stretching portion with a voice signal indicating the model voice to specify a different part between the both voice signals, a signal processing portion which applies a signal processing of emphasizing the different part specified by the specifying portion to one of the voice signal input into the inputting portion and the voice signal indicating the model voice, and an outputting portion which outputs a voice signal to which the signal processing is applied by the signal processing portion.

### TECHNICAL FIELD

The present invention relates to the technology of aiding the language learning by using voice data and, more particularly, the technology of informing a learner of a difference between a voice emitted by the learner and a model voice as an example.

### BACKGROUND ART

In recent years, the technology of aiding the language learning such as the learning of English conversation, or the like by using voice data comes into widespread use in general. As examples of such technology, there are the technologies disclosed in Patent Literatures 1 to 3.

In Patent Literature 1, such a technology is disclosed that a learner is caused to comprehend a different part between a standard voice and an emitted voice and a degree of the difference by dividing the emitted voice from the learner in unit of syllable in terms of a voice recognition, comparing the emitted voice with the standard voice stored previously in unit of syllable, and displaying the a different part between both voices and a numerical value indicating a degree of the difference on a screen, and thus the learner is enabled to practice himself or herself in making the learner's voice more similar to the standard voice.

In Patent Literature 2, the pronunciation learning apparatus equipped with a voice recognizing portion for converting the user's pronunciation into character data composed of a plurality of words, a comparing portion for comparing the character data with illustrative sentence data composed of a plurality of words word by word, and a displaying portion for displaying visually distinctively matched words and unmatched words based on the compared result in the comparing portion is disclosed. According to this pronunciation learning apparatus, even though the user's pronunciation is poor as a whole, it is possible for the user to grasp the part where learner's problem of the pronunciation lies.

In Patent Literature 3, such a foreign language self-adapting learning apparatus is disclosed that a voice inputting portion for inputting the voice emitted by the learner, a voice recognizing portion for recognizing a voice input from the voice inputting portion and making a voice recognition, a voice recognizing resource portion in which criteria for voice evaluations, characteristic points such as a degree of difficulty of the pronunciation, etc. are registered, and a voice displaying portion for displaying the voice recognition result of the voice emitted by the learner are provided, and difficult pronunciations in the learning are emphasized based on features of the learner's mother tongue and the learned language and also the words whose pronunciation is different is highlighted on a display by comparing the learner's voice with the registered contents in the voice recognizing resource portion.

Patent Literature 1: JP-A-2003-162291

Patent Literature 2: JP-A-2002-175095

Patent Literature 3: JP-A-2001-249679

### DISCLOSURE OF THE INVENTION

### Problems that the Invention is to Solve

However, in the technologies disclosed in Patent Literatures 2 and 3, only different parts from the voice as the example are offered. Therefore, there are such problems that the learner cannot grasp to what extent the different parts are different, how the different parts should be improved, and the like. Also, according to the technology disclosed in Patent Literature 1, a degree of the difference as well as the different part is disclosed. In this case, since a degree of the difference is displayed in a numerical form, the learner cannot concretely grasp how the different parts should be improved.

Also, in the technologies disclosed in Patent Literatures 1 to 3, it is assumed that, upon comparing the voice emitted by the learner and the voice as a sample (referred to as “a model voice” hereinafter) as an example, the voice recognition is applied to the voice emitted by the learner. In this case, generally a voice recognition algorithm is extremely complicated, and therefore such a problem exists that a configuration of the system for carrying out the algorithm also becomes complicated.

The present invention has been made in view of the above problems, and it is an object of the present invention to provide the technology that enables a learner to grasp concretely a different part between a voice emitted by the learner and a model voice as an example and a degree of the difference with a simple configuration.

### Means for Solving the Problems

In order to solve the above problem, the present invention provides a language learning apparatus, which includes an inputting portion to which a voice signal is input, a time stretching portion which compresses or expands the voice signal in a time axis direction such that a phonation period of a voice indicated by the voice signal input into the inputting portion is matched with a phonation period of a model voice, a specifying portion which compares the voice signal which is compressed or expanded by the time stretching portion with a voice signal indicating the model voice to specify a different part between the both voice signals, a signal processing portion which applies a signal processing of emphasizing the different part specified by the specifying portion to one of the voice signal input into the inputting portion and the voice signal indicating the model voice, and an outputting portion which outputs a voice signal to which the signal processing is applied by the signal processing portion.

According to such language learning apparatus, when the voice signal indicating the voice emitted by the user is input into the inputting portion, the voice signal in which the different part between the voice and a predetermined model voice is emphasized is output from the outputting portion. Then, when the voice signal being output in this manner is supplied to the sounding device such as the speaker, or the like and then the voice is emitted in response to the voice signal, the user can grasp concretely the different part and a degree of the difference.

Here, as the signal process, a process of inserting a signal indicating a phoneme before and after the different part, a process of increasing a sound volume of the different part, a process of replacing the different part with a corresponding part of the voice signal indicating in the model voice, a process of superposing a white noise on parts except the different part, and a process of replacing respective parts except the different part with a corresponding part in the voice signal indicating in the model voice can be listed.

Preferably, the time stretching portion compares the phonation period of the voice indicated by the voice signal input into the inputting portion with the phonation period of the model voice in unit of a predetermined time period to compress or expand the voice signal in the time period in the time axis direction in response to a result of the comparison. Here, as an example of the predetermined time period, the phrase partitioned by the pause can be listed. In such way, only in the time period in which the phonation period is different from the model voice (e.g., the time period that is stretched longer than that of the model voice), the compression or expansion of the voice signal corresponding to that time interval is applied.

Also, it is preferable that, the time stretching portion compares the voice signal input into the inputting portion with the voice signal indicating the model voice in unit of the time period to compress or expand the voice signal in the time period in the time axis direction when a degree of divergence between the both voice signals is greater than or equal to a predetermined threshold value.

Also, it is preferable that, the outputting portion includes a first channel which is connected to a first speaker, and a second channel which is connected to a second speaker being different from the first channel. The outputting portion outputs the voice signal to which the signal processing is applied by the signal processing portion to the first channel, and outputs the other of the voice signal input into the inputting portion and the voice signal indicating the model voice to the second channel.

Also, in order to solve the above problem, the present invention provides a program that causes a computer to execute a first step of compressing or expanding a voice signal in a time axis direction such that a phonation period of a voice indicated by the voice signal being input is matched with a phonation period of a model voice, a second step of comparing the voice signal which is compressed or expanded in the first step with a voice signal indicating the model voice to specify a different part between the both voice signals, and a step of applying a signal processing of emphasizing the different part specified in the second step to one of the input voice signal and the voice signal indicating the model voice to output a voice signal to which the signal processing is applied.

According to such program, the same functions as those of the language learning apparatus according to the present invention can be attached to the common computer equipment by installing the program into such common computer equipment. Here, upon distributing the above program, for example, such program may be written in the computer-readable recording medium such as a CD-ROM (Compact Disk-Read Only Memory), or the like and then distributed, or such program may be distributed by the downloading via the telecommunication network such as the Internet, or the like.

Also, in order to solve the above problem, the present invention provides a computer-readable recording medium recording a program for causing a computer to execute a language learning aiding method that includes, a first step of compressing or expanding a voice signal in a time axis direction such that a phonation period of a voice indicated by the voice signal being input is matched with a phonation period of a model voice, a second step of comparing the voice signal which is compressed or expanded in the first step with a voice signal indicating the model voice to specify a different part between the both voice signals, and a step of applying a signal processing of emphasizing the different part specified in the second step to one of the input voice signal and the voice signal indicating the model voice to output a voice signal to which the signal processing is applied.

Also, in order to solve the above problem, the present invention provides a language learning aiding method, comprising: compressing or expanding a voice signal input to an inputting portion in a time axis direction such that a phonation period of a voice indicated by the input voice signal is matched with a phonation period of a model voice; comparing the voice signal which is compressed or expanded with a voice signal indicating the model voice to specify a different part between the both voice signals; applying a signal processing of emphasizing the specified different part to one of the input voice signal and the voice signal indicating the model voice; and outputting a voice signal to which the signal processing is applied.

Preferably, the time stretching process compares the phonation period of the voice indicated by the input voice signal with the phonation period of the model voice in unit of a predetermined time period to compress or expand the voice signal in the time period in the time axis direction in response to a result of the comparison.

Preferably, the time stretching process compares the input voice signal with the voice signal indicating the model voice in unit of the time period to compress or expand the voice signal in the time period in the time axis direction when a degree of divergence between the both voice signals is greater than or equal to a predetermined threshold value.

Preferably, the signal processing is any one of a process of inserting a signal indicating a phoneme before and after the different part, a process of increasing a sound volume of the different part, and a process of replacing the different part with a corresponding part of the other of the input voice signal and the voice signal indicating the model voice.

Preferably, the signal processing is any one of a process of superposing a white noise on parts except the different part, and a process of replacing the parts except the different part with corresponding parts of the other of the input voice signal and the voice signal indicating the model voice.

Preferably, the voice signal to which the signal processing is applied is output a first channel which is connected to a first speaker. The other of the input voice signal and the voice signal indicating the model voice is output to a second channel which is connected to a second speaker being different from the first channel.

### ADVANTAGES OF THE INVENTION

According to the present invention, the different part between the voice emitted by the learner and the model voice is emphasized, and also the learner is informed of the different part and a degree of the difference by the voice. Therefore, such an advantage can be achieved that the learner can grasp concretely how and to what extent the different part should be improved.

Also, according to the present invention, there is no need to apply the voice recognition to the voice emitted from the learner. Therefore, such an advantage can be achieved that the language learning can be aided by the system whose configuration is simple rather than the prior art that needs the voice recognition.

### BRIEF DESCRIPTION OF THE DRAWINGS

FIG. 1 A diagram showing a configurative example of a language learning apparatus 1 according to an embodiment of the present invention.

FIG. 2 A table showing an example of an illustrative sentence table TB1 written previously into a storing portion 105 of the same language learning apparatus 1.

FIG. 3 A view showing an example of an operating screen displayed on a displaying portion 106 of the same language learning apparatus 1.

FIG. 4 A flowchart showing a flow of an evaluating operation that a controlling portion 102 of the same language learning apparatus 1 executes.

FIG. 5 A view showing an example of a time stretch process that the controlling portion 102 executes.

### DESCRIPTION OF REFERENCE NUMERALS

1 language learning apparatus
101 bus
102 controlling portion
103 ROM
104 RAM
105 storing portion
106 displaying portion
107 operating portion
108 voice processing portion
109 microphone
110 speaker

### BEST MODE FOR CARRYING OUT THE INVENTION

An embodiment of the present invention will be explained with reference to the drawings hereinafter.

(A. Configuration)

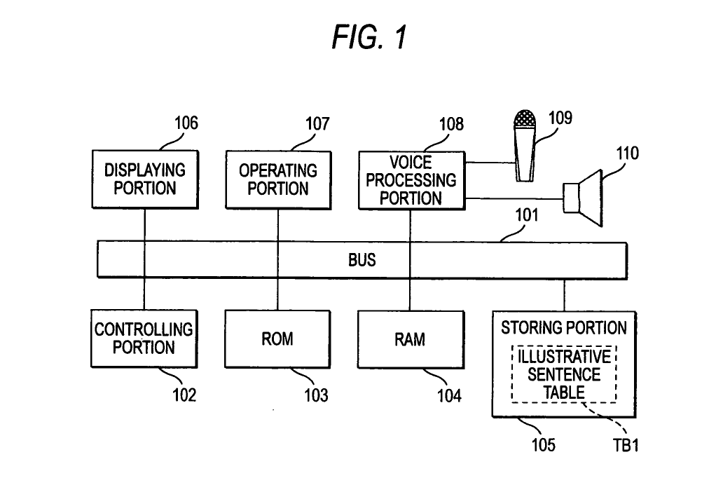

FIG. 1 is a block diagram illustrating a hardware configuration of a language learning apparatus 1 according to an embodiment of the present invention. As shown in FIG. 1, respective portions of the language learning apparatus 1 are connected to a bus 101, and the language learning apparatus 1 transfers signals and data between respective portions via the bus 101.

A microphone 109 is connected to a voice processing portion 108, and converts an input voice into an electric signal in analog form (referred to an “analog voice signal” hereinafter) and outputs this signal to the voice processing portion 108. A speaker 110 is connected to the voice processing portion 108, and emits a voice corresponding to the analog voice signal output from the voice processing portion 108. The voice processing portion 108 is equipped with an A/D converting function of converting the analog voice signal input from the microphone 109 into a digital voice signal to output, and a D/A converting 102 function of converting the digital voice signal supplied from a controlling portion 102 into the analog voice signal and outputting this signal to the speaker 110.

In the present embodiment, the case where the microphone 109 and the speaker 110 are built in the language learning apparatus 1 is explained. In this case, an input terminal and an output terminal may be provided to the voice processing portion 108, and an external microphone may be connected to the input terminal via an audio cable. Similarly, an external speaker may be connected to the output terminal via the audio cable. Also, in the present embodiment, the case where both the voice signal being input from the microphone to the voice processing portion 108 and the voice signal being output from the voice processing portion 108 to the speaker are the analog voice signal is explained. In this case, the digital voice signal may be of course input/output. In such case, it is needless to say that there is no need to apply the A/D conversion and the D/A conversion in the voice processing portion 108.

A displaying portion 106 contains a display device such as a liquid crystal display, or the like and a driving circuit, for example, and displays texts, various messages, an operating screen for the language learning apparatus 1, etc. under control of the controlling portion 102. An operating portion 107 is equipped with an input device such as a keyboard, a mouse (both not shown), and the like, and outputs a signal indicating the operation contents to the controlling portion 102 in response to a key press, a mouse operation, or the like. The displaying portion 106 and the operating portion 107 provides the user interface that makes it possible for the user to utilize the language learning apparatus according to the present embodiment.

A storing portion 105 is a HDD (Hard Disk Drive), for example, and stores various data.

Concretely, digital voice signals indicating the model voice as the voice that the native speaker reads out the illustrative sentences in the object language (referred to as “model voice signals” hereinafter) while correlating them with text data representing illustrative sentences used in the language learning (sentences described in the object language of the language learning)(referred to as “illustrative sentence text data” hereinafter) are stored in the storing portion 105.

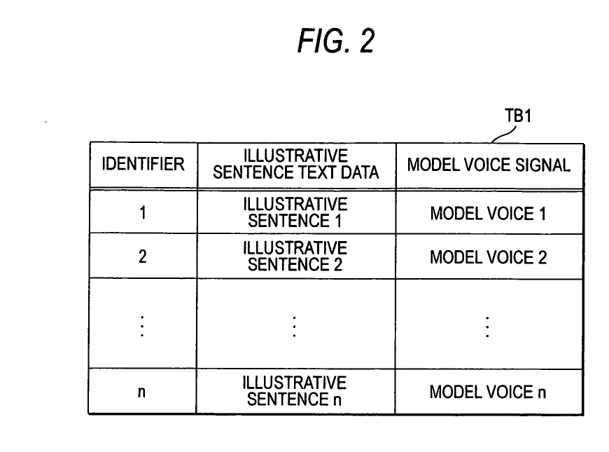

To explain in more detail, an illustrative sentence table TB1 in a format illustrated in FIG. 2 is stored in the storing portion 105. In this illustrative sentence table TB1, the above illustrative sentence text data, the model voice signals, and identifiers used to identify uniquely respective illustrative sentence text data are stored to correlate mutually. Although the details will be described later, the text data and the identifiers stored in the illustrative sentence table TB1 are utilized when the user who does the language learning by using the language learning apparatus 1 (referred to as a “learner” hereinafter) chooses the illustrative sentence to be learned, while the model voice signals stored in the illustrative sentence table TB1 are utilized when the user causes the controlling portion 102 to specify the different part between the voice emitted by the learner (referred to as a “learner's voice” hereinafter) and the model voice and a degree of the difference. In the present embodiment, the case where the illustrative sentence text data and the model voice signals are stored in the illustrative sentence table TB1 is explained. But it may be of course employed that the illustrative sentence text data and the model voice signals are stored in the memory areas different from the illustrative sentence table TB1 and also the data indicating the memory locations of the illustrative sentence text data and of the model voice signals (e.g., head addresses of the memory locations, etc.) are stored in the illustrative sentence table TB1.

The controlling portion 102 is a CPU (Central Processing Unit), for example. When a power supply (not shown) of the language learning apparatus 1 is turned ON, the controlling portion 102 reads a control program stored in a ROM (Read Only Memory) 103 and executes this program while utilizing a RAM (Random Access Memory) 104 as a work area.

Although the details will be described later, a function of letting the learner choose the illustrative sentence to be learned and a function of comparing the learner's voice input via the microphone 109 with the model voice corresponding to the illustrative sentence chosen by the learner to specify the different part between them and a degree of the difference and inform the learner of the specified result are attached to the controlling portion 102 that works in compliance with this control program. In the present embodiment, the case where the control program is written previously in the ROM 103 is explained. In this case, it may be of course employed that the control program is written previously in the storing portion 105. Also, in the present embodiment, the case where the controlling portion 102 is caused to start the execution of the control program in response to the turn-ON of the power supply (not shown) of the language learning apparatus 1 as a trigger is explained. In this case, it may be of course employed that, in response to the turn-ON of the power supply as a trigger, first the controlling portion 102 is caused to start OS (Operating System), and then the control program is executed by the controlling portion 102 under control of the OS.

With the above, a hardware configuration of the language learning apparatus 1 according to the present embodiment is given. In this manner, the hardware configuration of the language learning apparatus 1 according to the present embodiment is identical to the hardware configuration of the common computer equipment, and characteristic functions of the language learning apparatus according to the present invention are realized by operating the controlling portion 102 in compliance with a control software (i.e., a software module).

(B. Operation)

Next, operations that the controlling portion 102 of the same language learning apparatus 1 executes in compliance with the language learning program will be explained with reference to the drawings hereunder. As described above, when the power supply (not shown) of the language learning apparatus 1 is turned ON, the controlling portion 102 reads the control program from the ROM 103 and starts the execution of this control program. The controlling portion 102 that is operating in compliance with this control program displays an operating screen that calls upon the learner to utilize the language learning apparatus 1 on the displaying portion 106.

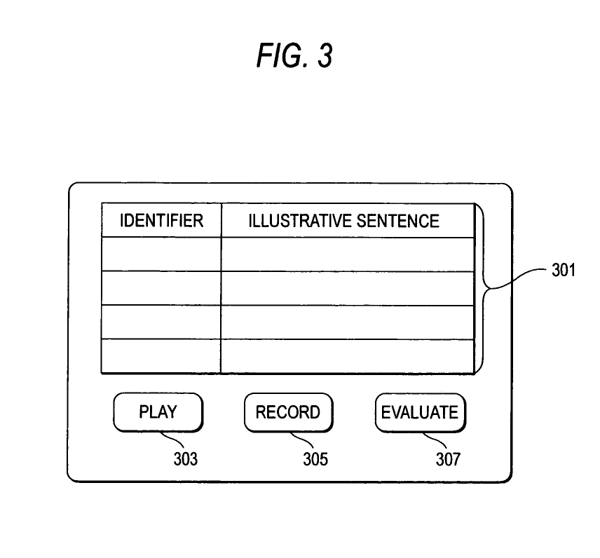

FIG. 3 is a view showing an example of the operating screen displayed on the displaying portion 106.

A display area 301 on the operating screen shown in FIG. 3 is an area used to offer the learnable illustrative sentence to the learner. In the present embodiment, the controlling portion 102 list-displays identifiers and illustrative sentence text data read from the illustrative sentence table TB1 on the display area 301.

The learner can choose the illustrative sentence that the learner wishes to learn from the illustrative sentence text data list-displayed on the display area 301 by choosing appropriately the operating portion 107. Then, when the learner chooses the illustrative sentence by operating the operating portion 107, the signal indicating the chosen content (e.g., the signal indicating the identifier of the chosen illustrative sentence) is transferred from the operating portion 107 to the controlling portion 102, and the signal informing which illustrative sentence has been chosen is transmitted to the controlling portion 102.

The controlling portion 102 to which the content chosen by the learner is transmitted in this manner reads the model voice signal responding to the chosen content (i.e., the model voice signal corresponding to the illustrative sentence chosen by the learner) from the illustrative sentence table TB1, and then writes this signal into the RAM 104. Accordingly, the model voice acting as the pronunciation sample of the illustrative sentence chosen by the learner is decided.

A play button 303 on the operating screen shown in FIG. 3 is an operating piece that indicates to output the model voice corresponding to the illustrative sentence chosen by the learner. When the play button 303 is pressed after the choose of the illustrative sentence is done on the operating screen shown in FIG. 3 by the learner, the signal indicating that the play button 303 has been pressed is transferred from the operating portion 107 to the controlling portion 102.

The controlling portion 102, when received the signal indicating that the play button 303 has been pressed, transfers the model voice signal stored in the RAM 104 to the voice processing portion 108 to convert this signal into the analog voice signal, and then outputs the analog voice signal to the speaker 110 to emit the model voice corresponding to the illustrative sentence chosen by the learner. The learner listens to the model voice emitted in this manner, and can check how the illustrative sentence chosen by the learner's own self is to be pronounced. In this case, when the choose of the illustrative sentence is not done prior to the press of the play button 303, the message of calling upon the learner to press the play button 303 after the illustrative sentence is chosen may be output.

A record button 305 on the operating screen shown in FIG. 3 is an operating piece that indicates to record the learner's voice. When the record button 305 is pressed on the operating screen shown in FIG. 3, the signal indicating to the effect is transferred from the operating portion 107 to the controlling portion 102. The controlling portion 102 waits for the learner's voice that is input via the microphone 109. Then, when the learner emits the voice to the microphone 109, the analog signal indicating the learner's voice is transferred from the microphone 109 to the voice processing portion 108, then is converted into the digital signal (referred to as a “learner's voice signal” hereinafter) by the voice processing portion 108, and then is transferred to the controlling portion 102. The controlling portion 102 received the learner's voice signal in this manner records the learner's voice by writing the learner's voice signal into the RAM 104.

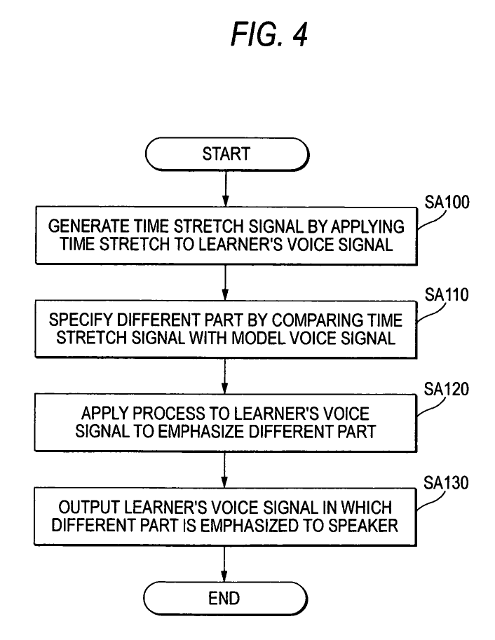

An evaluate button 307 on the operating screen shown in FIG. 3 is an operating piece that evaluates the difference between the model voice corresponding to the illustrative sentence chosen by the learner and the learner's voice emitted by the learner in conformity with the illustrative sentence, and indicates to inform the evaluated result. When the evaluate button 307 is pressed on the operating screen shown in FIG. 3, the signal indicating to the effect is transferred from the operating portion 107 to the controlling portion 102. The controlling portion 102 when received this signal starts the execution of an evaluating process shown in FIG. 4. In this case, when the choose of the illustrative sentence or the recording of the learner's voice is not done prior to the press of the evaluate button 307, the message of calling upon the learner to press the evaluate button 307 after these operations are executed may be output.

FIG. 4 is a flowchart showing a flow of the evaluating process that the controlling portion 102 executes in compliance with the control program. As shown in FIG. 4, first the controlling portion 102 generates the voice signal to which a time stretch is applied (referred to as a “time stretch signal” hereinafter) from the learner's voice signal stored in the RAM 104, separately from the learner's voice signal (step SA100).

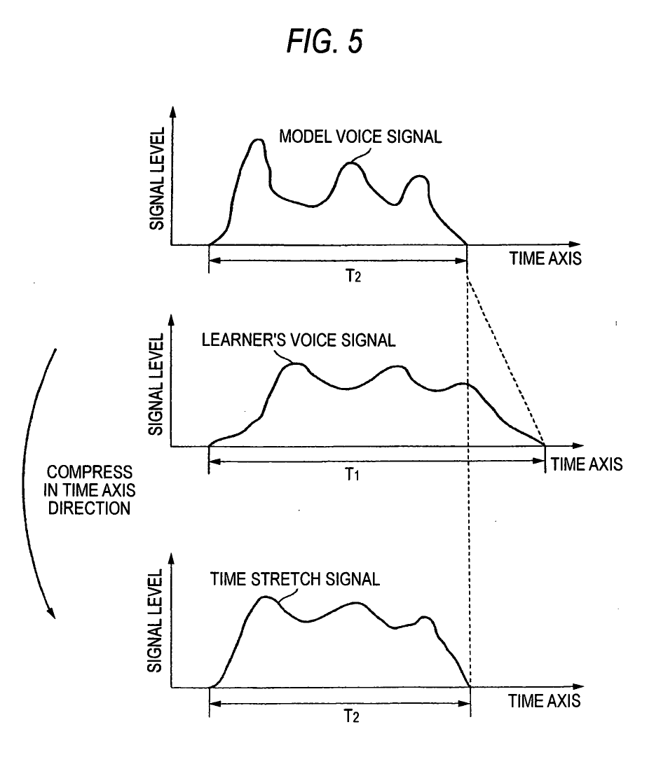

Here, as shown in FIG. 5, the time stretch is a process that aligns a phonation period T1 of the learner's voice with a phonation period T2 of the model voice corresponding to the illustrative sentence chosen by the learner, i.e., a process that compresses or expands the learner's voice signal uniformly in a time axis direction based on a ratio of the latter to the former (i.e., T2/T1). For example, since T1>T2 in an example shown in FIG. 5, the time stretch signal is generated in this operation example by compressing the learner's voice signal at a ratio of T2>T1 in a time axis direction.

In this case, the reason why the time stretch signal is generated by applying the above time stretch to the learner's voice signal is that, even when the learner's voice signal and the model voice signal are compared with each other in a situation that the phonation period T1 of the learner's voice is different from the phonation period T2 of the model voice, it is of course decided that both signals are different mutually and thus essential different parts such as differences in an accent position, an intonation, etc. between them cannot be specified.

Then, the controlling portion 102 compares the time stretch signal generated in step SA100 with the model voice signal stored in the RAM 104 to specify the different part between them (step SA110). To explain in more detail, in the present embodiment, the controlling portion 102 specifies the different parts by executing processes explained in the following.

First, the controlling portion 102 calculates a signal level, a frequency spectrum, and the like in time series by applying the FFT analysis to the time stretch signal generated in step SA100, and analyses the pronunciation of the voice indicated by the time stretch signal. The information extracted by this analysis (referred to as “pronunciation information” hereinafter) are a stress accent, a tonic accent, an intonation, and the like.

The “stress accent” is a location that is pronounced strongly in the phrase that is partitioned by a pause (i.e., a location where a signal level is high), and a timing and a level are extracted. Also, the “tonic accent” is a location that is pronounced highly in the phrase (i.e., a location where a fundamental frequency is high), and a timing and a frequency are extracted. Also, the “intonation” is a high/low intonation (fundamental frequency) of the phrase, and an intonation curve is analyzed and treated as a function. In this case, the fundamental frequency is a peak whose frequency is lowest among peaks that are derived by the FFT analysis. In addition, pronounced vowels can be analyzed by extracting formants from the frequency spectrum. Further, a harmonic constituent ratio can be calculated from the frequency spectrum, and it can be evaluated that the vowels are different if this time variation is different.

When the controlling portion 102 extracts pronunciation information by applying the analysis to the time stretch signal, and also extracts pronunciation information by applying the analysis to the model voice signal as a compared object. Then, the controlling portion 102 compares the pronunciation information extracted from the time stretch signal and the pronunciation information extracted from the model voice signal in time series every type. When a degree of alienation of the former pronunciation information from the latter pronunciation information is in excess of a predetermined threshold value, the controlling portion 102 specifies the location indicated by the pronunciation information (e.g., the timing indicated by the pronunciation information when this pronunciation information is about the stress accent) as the different part.

According to the above processes, the locations where the stress accent, the tonic accent, or the intonation is different from the model voice are specified as the different parts. In the present operation example, the case where the different parts between the time stretch signal and the model voice are specified by comparing the pronunciation information generated by calculating the FFT analysis, the signal level, the frequency spectrum, and the like in time series is explained. In this case, the different parts may be specified by the well-known approach.

Then, the controlling portion 102 applies a predetermined signal process to the learner's voice signal stored in the RAM 104 to emphasize the different part specified in step SA110 (step SA120). In the present operation example, the controlling portion 102 applies a process that inserts a signal indicating a predetermined beep sound before and after the part corresponding to the different part specified in step SA110 in the learner's voice signal (i.e., the part of the learner's voice signal specified at a timing that is obtained by applying an inverse transformation of the above time stretch to timings indicating a head and a tail of the different part specified in step SA110) as the above predetermined signal process. In the language learning apparatus 1 according to the present embodiment, since three type differences, i.e., a difference in the stress accent, a difference in the tonic accent, and a difference in the intonation can be specified as the difference of the learner's voice from the model voice, the beep sound having a different timbre may be inserted in answer to the type of difference.

Then, the controlling portion 102 hands over the learner's voice signal to which the predetermined signal processing is applied in step SA120 to the voice processing portion 108, and causes the speaker 110 to emit the voice in response to the learner's voice signal (step SA130). Then, this evaluation operation is ended.

As a result of the operation explained above, the beep sound is inserted before and after the different part between the learner's voice and the model voice in the voice emitted from the speaker 110, and thus the learner can grasp easily the different part. Also, according to the language learning apparatus 1 according to the present embodiment, when the learner listens to the emitted voice and the model voice emitted by pressing the play button 303 while comparing them based on the above evaluation operation, such learner can grasp concretely a degree of the difference of the different part and also can grasp concretely how and to what extent the different part should be improved. Also, in the language learning apparatus 1 according to the present embodiment, since the voice of the native speaker is used as the model voice, the learner can acquire the pronunciation close to the native speaker.

Also, according to the language learning apparatus 1 according to the present embodiment, there is no need to apply the voice recognition to the learner's voice upon specifying the different part. Therefore, a configuration of the language learning apparatus can be simplified rather than the prior art that utilizes the voice recognition as a premise.

(C. Variations)

The embodiment of the present invention is explained as above, but it is of course that variations described as follows may be applied to the above embodiment.

(1) In the above embodiment, the case where the model voice signals are stored previously in the storing portion 105 of the language learning apparatus 1 is explained. In this case, for example, when the illustrative sentence table TB1 is stored in the computer equipment connected to the communication network such as the Internet, or the like and also a communication interface portion used to transmit/receive the data via the communication network is provided to the language learning apparatus according to the present embodiment, the model voice signal may of course be obtained from the computer equipment via the communication network.

(2) In the above embodiment, the case where the learner's voice signal is compressed or expanded uniformly in a time axis direction based on a ratio of the latter to the former such that the phonation period of the learner's voice is aligned with the phonation period of the corresponding model voice is explained. However, the phonation period of the learner's voice and the phonation period of the model voice may be compared mutually in unit of a predetermined time period such as the phrase partitioned by the pause, or the like, for example, and then the learner's voice signal may be compressed or expanded in the time axis direction at a ratio responding to the compared result every time interval. If this process is done, not only the time period in which the phonation period is different from the model voice can be compressed or expanded in the time axis direction but also the voiceless interval can be removed from the object of the time stretch.

Also, in case the learner's voice compressed or expanded in the time axis direction in unit of the predetermined time period, the learner's voice signal and the model voice signal may be compared mutually in unit of the predetermined time period and then the learner's voice signal corresponding to the time period may be compressed or expanded in the time axis direction when a degree of alienation of the learner's voice from the model voice is in excess of a predetermined threshold value. When this approach is adopted, the time stretch can be applied to the learner's voice signal only in the time period in which the learner's voice and the model voice are apparently different, and the difference from the model voice signal can be specified in detail. Therefore, such an advantage can be obtained that the different part between the learner's voice and the model voice and a degree of the difference can be specified effectively.

In the present variation, the case where the phrase partitioned by the pause is used as the predetermined time period is explained. In this case, it is of course that a signal waveform of the learner's voice signal and a signal waveform of the model voice signal may be compared mutually in unit of a minute time such as a frame, or the like by the well-known technology such as the DP matching, for example, to specify the corresponding location between them, and then the corresponding location may be used as the pause of the time period.

(3) In the above embodiment, the case where the different part between the learner's voice and the model voice is emphasized by applying the process of inserting the beep sound before and after the different part to the learner's voice signal is explained. In this case, for example, the different part may be emphasized by inserting a silent portion before and after the different part for a predetermined time. In short, any mode may be employed if the different part can be emphasized by inserting a predetermined phoneme such as the silent portion, the beep sound, or the like before and after the different part, and also any content may be employed as the phoneme to be inserted. Also, the signal processing of emphasizing the different part is not limited to the process that inserts the predetermined phoneme before and after the different part. For example, the process of increasing a sound volume of the different part more largely than other parts may be employed, or the process of replacing the different part with the concerned part in the model voice signal may be employed. Also, the process of superposing a white noise on parts except the different part may be employed, or the process of replacing respective parts except the different part with the concerned part in the model voice signal may be employed. Also, the process of repeating the different part in predetermined times may be employed. In summary, any mode may be employed if the signal processing can emphasize the different part between the learner's voice and the model voice in the learner's voice.

(4) In the above embodiment, the case where the signal processing of emphasizing the different part between the learner's voice and the model voice is applied to the learner's voice signal is explained. In this case, it is of course that the signal processing of emphasizing the different part from the learner's voice may be applied to the model voice signal and then the model voice signal that is subjected to such signal processing may be supplied to the speaker 110. This is because such mode also enables the learner to grasp the different part between the voice emitted by the learner himself or herself and the model voice and a degree of the difference. Here, as examples of the signal processing applied to the model voice signal to emphasize the different part from the learner's voice, there may be listed the process of inserting the predetermined phoneme such as the silent portion, the beep sound, or the like before and after the different part, the process of increasing a sound volume of the different part more largely than other parts, the process of replacing the different part with the concerned part in the model voice signal, the process of superposing a white noise on parts except the different part, the process of replacing respective parts except the different part with the concerned part in the learner's voice signal, and the like.

(5) In the above embodiment, the case where the learner is informed of the different part and a degree of the difference by emitting the learner's voice to which the process of emphasizing the different part is applied from the speaker 110 is explained. However, a first output terminal corresponding to a first channel and a second output terminal corresponding to a second channel may be provided to the voice processing portion 108, then a right-channel speaker may connected to the first output terminal and a left-channel speaker may connected to the second output terminal, and then the learner's voice signal to which the process of emphasizing the different part is applied may be output to the first channel whereas the model voice signal may be output to the second channel.

When this approach is adopted, the learner's voice to which the process of emphasizing the different part is applied is emitted from the right-channel speaker, and the model voice is emitted from the left-channel speaker. Therefore, the learner can be formed of the different part between both voices and a degree of the difference to understand easily. In this event, when the learner's voice to which the process of emphasizing the different part is applied and the model voice are emitted from the different speakers respectively, a playing speed of one voice may be matched with a playing speed of the other voice (e.g., a playing speed of the model voice may be matched with a playing speed of the learner's voice to which the process of emphasizing the different part is applied), or an average pitch of one voice may be matched with an average pitch of the other voice.

Also, in the mode that the learner's voice to which the process of emphasizing the different part is applied is emitted from one speaker, an electronic sound indicating the intonation of the model voice may be emitted from the other speaker. Such approach can be accomplished by emitting the electronic sound whose pitch is changed in accordance with the pronunciation information about the intonation that is generated by analyzing the model voice.

(6) In the above embodiment, the case where the learner is informed of the different part and a degree of the difference by emitting the voice corresponding to the learner's voice signal to which the process of emphasizing the different part between the learner's voice and the model voice is applied is explained. In this case, it is of course that the indication of the different part by the display disclosed in Patent Literatures 1 to 3 may be employed together with the indication by the sound.

Also, in the above embodiment, the case where the user interface for calling upon the learner to use the language learning apparatus according to the present embodiment is provided by displaying the operating screen shown in FIG. 3 on the displaying portion 106 is explained. In this case, for example, the user interface may be provided by emitting the voice guidance that calls upon the learner to execute the operations for indicating sequentially the selection of the illustrative sentence, the playing of the model voice, the recording of the learner's voice, and the evaluation of the learner's voice. In such mode, it is needless to say that, when the different part between the learner's voice and the model voice and a degree of the difference are indicated by the voice only, the displaying portion 106 should not be provided to the language learning apparatus.

(7) In the above embodiment, the case where the characteristic functions of the language learning apparatus according to the present invention are accomplished by the software module is explained. It is of course that these characteristic functions may be accomplished. Concretely, the language learning apparatus may be constructed by using in combination an inputting portion to which the learner's voice signal is input, a time stretching portion for generating the time stretch signal by applying the time stretch to the voice signal, a specifying portion for comparing the time stretch signal with the model voice signal to specify the different part between them, a signal processing portion for applying a predetermined signal processing of emphasizing the different part to the learner's voice signal or the model voice signal, and an outputting portion for outputting the voice signal to which the predetermined signal processing is applied by the signal processing portion, and then by operating in combination respective portions in accordance with the flowchart shown in FIG. 4.

Also, in the above embodiment, the case where the program of causing the controlling portion to execute the characteristic functions of the language learning apparatus according to the present invention is stored in advance in the storing portion is explained. In this case, such program may be written in the computer-readable recording medium such as CD-ROM, or the like and then distributed, or such program may be distributed via the telecommunication network such as the Internet, or the like. When this approach is adopted, the same functions as those of the language learning apparatus according to the present invention can be attached to the common computer equipment by installing the program written in the recording medium or the program distributed via the telecommunication network into such common computer equipment.

1. A language learning apparatus, comprising:
an inputting portion to which a voice signal is input;
a time stretching portion which compresses or expands the voice signal in a time axis direction such that a phonation period of a voice indicated by the voice signal input into the inputting portion is matched with a phonation period of a model voice;
a specifying portion which compares the voice signal which is compressed or expanded by the time stretching portion with a voice signal indicating the model voice to specify a different part between the both voice signals;
a signal processing portion which applies a signal processing of emphasizing the different part specified by the specifying portion to one of the voice signal input into the inputting portion and the voice signal indicating the model voice; and
an outputting portion which outputs a voice signal to which the signal processing is applied by the signal processing portion.

2. The language learning apparatus according to claim 1, wherein the time stretching portion compares the phonation period of the voice indicated by the voice signal input into the inputting portion with the phonation period of the model voice in unit of a predetermined time period to compress or expand the voice signal in the time period in the time axis direction in response to a result of the comparison.

3. The language learning apparatus according to claim 2, wherein the time stretching portion compares the voice signal input into the inputting portion with the voice signal indicating the model voice in unit of the time period to compress or expand the voice signal in the time period in the time axis direction when a degree of divergence between the both voice signals is greater than or equal to a predetermined threshold value.

4. The language learning apparatus according to claim 1, wherein the signal processing is any one of a process of inserting a signal indicating a phoneme before and after the different part, a process of increasing a sound volume of the different part, and a process of replacing the different part with a corresponding part of the other of the voice signal input into the inputting portion and the voice signal indicating the model voice.

5. The language learning apparatus according to claim 1, wherein the signal processing is any one of a process of superposing a white noise on parts except the different part, and a process of replacing the parts except the different part with corresponding parts of the other of the voice signal input into the inputting portion and the voice signal indicating the model voice.

6. The language learning apparatus according to claim 1, wherein the outputting portion includes:
a first channel which is connected to a first speaker; and
a second channel which is connected to a second speaker being different from the first channel, and
wherein the outputting portion outputs the voice signal to which the signal processing is applied by the signal processing portion to the first channel, and outputs the other of the voice signal input into the inputting portion and the voice signal indicating the model voice to the second channel.

7. A language learning aiding method, comprising:
compressing or expanding a voice signal input to an inputting portion in a time axis direction such that a phonation period of a voice indicated by the input voice signal is matched with a phonation period of a model voice;
comparing the voice signal which is compressed or expanded with a voice signal indicating the model voice to specify a different part between the both voice signals;
applying a signal processing of emphasizing the specified different part to one of the input voice signal and the voice signal indicating the model voice; and
outputting a voice signal to which the signal processing is applied.

8. The language learning aiding method according to claim 7, wherein the time stretching process compares the phonation period of the voice indicated by the input voice signal with the phonation period of the model voice in unit of a predetermined time period to compress or expand the voice signal in the time period in the time axis direction in response to a result of the comparison.

9. The language learning aiding method according to claim 8, wherein the time stretching process compares the input voice signal with the voice signal indicating the model voice in unit of the time period to compress or expand the voice signal in the time period in the time axis direction when a degree of divergence between the both voice signals is greater than or equal to a predetermined threshold value.

10. The language learning aiding method according to claim 7, wherein the signal processing is any one of a process of inserting a signal indicating a phoneme before and after the different part, a process of increasing a sound volume of the different part, and a process of replacing the different part with a corresponding part of the other of the input voice signal and the voice signal indicating the model voice.

11. The language learning aiding method according to claim 7, wherein the signal processing is any one of a process of superposing a white noise on parts except the different part, and a process of replacing the parts except the different part with corresponding parts of the other of the input voice signal and the voice signal indicating the model voice.

12. The language learning aiding method according to claim 7, wherein the voice signal to which the signal processing is applied is output a first channel which is connected to a first speaker; and
wherein the other of the input voice signal and the voice signal indicating the model voice is output to a second channel which is connected to a second speaker being different from the first channel.

13. A program for causing a computer to execute:
a first step of compressing or expanding a voice signal in a time axis direction such that a phonation period of a voice indicated by the voice signal being input is matched with a phonation period of a model voice;
a second step of comparing the voice signal which is compressed or expanded in the first step with a voice signal indicating the model voice to specify a different part between the both voice signals; and
a step of applying a signal processing of emphasizing the different part specified in the second step to one of the input voice signal and the voice signal indicating the model voice to output a voice signal to which the signal processing is applied.

14. A computer-readable recording medium recording a program for causing a computer to execute a language learning aiding method that includes:
a first step of compressing or expanding a voice signal in a time axis direction such that a phonation period of a voice indicated by the voice signal being input is matched with a phonation period of a model voice;
a second step of comparing the voice signal which is compressed or expanded in the first step with a voice signal indicating the model voice to specify a different part between the both voice signals; and
a step of applying a signal processing of emphasizing the different part specified in the second step to one of the input voice signal and the voice signal indicating the model voice to output a voice signal to which the signal processing is applied.
